(19) United States
(12) Patent Application Publication
(10) Pub. No.: US 2023/0266230 A1
(43) Pub. Date: Aug. 24, 2023

(54) DISEASE DIAGNOSIS KIT, DISEASE DIAGNOSIS METHOD USING THE DISEASE DIAGNOSIS KIT AND METHOD FOR MANUFACTURING THE DISEASE DIAGNOSIS KIT

(71) Applicant: Kyungpook National University Industry-Academic Cooperation Foundation, Daegu (KR)

(72) Inventors: Sungwook Nam, Daegu (KR); Dong Il Won, Daegu (KR)

(21) Appl. No.: 18/147,872

(22) Filed: Dec. 29, 2022

Related U.S. Application Data
(60) Provisional application No. 63/313,353, filed on Feb. 24, 2022.

(51) Int. Cl. G01N 21/01; B01L 3/00

(52) U.S. Cl. CPC G01N 21/01; B01L 3/502715; B01L 3/502707; B01L 2300/0816; B01L 2400/0487; G01N 2021/0106; B01L 2300/0861; B01L 2400/082; B01L 2200/16; B01L 2200/027; G01N 2001/027

(57) ABSTRACT

A kit for diagnosing a disease includes a micro device including a flow path through which a sample to be diagnosed flows, and one or more grooves at a bottom portion of the flow path, and an aperture having an opening corresponding with the flow path.

### TECHNICAL FIELD

The present invention relates to a disease diagnosis kit, a disease diagnosis method using the disease diagnosis kit, and a method of manufacturing the disease diagnosis kit. More particularly, the present invention relates to a disease diagnosis kit including a micro device and an aperture, a disease diagnosis method using the same, and a method of manufacturing the same.

### BACKGROUND

In the conventional case, methods of diagnosing diseases through a reaction of samples by injecting samples into microfluidic device are used for diagnosing diseases. However, in the conventional microfluidic device, it is difficult to mix the two solutions when one or more solutions are provided due to laminar flow phenomenon, and this problem corresponds to one of the major problems in inducing chemical reactions necessary for molecular biology research and diagnosis.

In order to overcome the problem, various types of micromixer structures have been proposed, but the structures are complicated and impractical. In particular, when using a generally known semiconductor process-based manufacturing method, the manufacturing cost is very high, so that there is a problem in that it is difficult to commercialize the micromixer structures economically.

### SUMMARY

The present invention has been made in an effort to provide a method of manufacturing a micro device with low manufacturing costs.

The present invention has also been made in an effort to provide a disease diagnosis method using a micro device, and a disease diagnosis kit including the micro device.

The problem to be solved by the present invention is not limited to the above-mentioned problems, and the not-mentioned problems will be clearly understood by those skilled in the art from the present specification and the accompanying drawings.

An example embodiment of the present invention discloses a kit for diagnosing a disease.

The kit may include: a micro device including a flow path through which a sample to be diagnosed flows, and one or more grooves at a bottom portion of the flow path; and an aperture having an opening corresponding with the flow path.

According to the example embodiment, kit may further include a flow rate adjusting device configured to adjust a flow rate of the sample flowing through the flow path of the micro device.

According to the example embodiment, the micro device may further include: an inlet through which the sample is injected; and an outlet through which the sample is discharged, and wherein the kit may further comprise a tube connected to the inlet and configured to inject the sample into the inlet.

According to the example embodiment, the flow rate adjusting device is coupled to the outlet to adjust a flow rate of the sample to a speed at which the sample flowing in the flow path is trapped in the one or more grooves.

According to the example embodiment, the flow rate adjusting device may be coupled to the outlet to adjust the flow rate of the sample flowing in the flow path to 15 m L/min or more.

According to the example embodiment, a cross-sectional area of the groove adjacent the flow path is narrower than a cross-sectional area of the groove far from the flow path.

According to the example embodiment, the kit may further include a reagent capable of reacting with the sample.

Another example embodiment of the present invention discloses a method of diagnosing a disease by using the kit.

The method may include: injecting the sample into the micro device; injecting a reagent reacting with the sample into the micro device; locating the aperture over the micro device to observe the flow path; and inserting the micro device to a device capable of determining optical density to diagnose a disease.

According to the example embodiment, the injecting of the sample into the micro device includes injecting the sample at a flow rate such that the sample is trapped in the one or more grooves.

According to the example embodiment, the injecting of the sample into the micro device includes injecting the sample at a flow rate such of about 15 mL/min or more.

According to the example embodiment, the injecting of the reagent reacting with the sample into the micro device includes injecting the reagent after the sample is trapped in the one or more grooves.

According to the example embodiment, the sample may be a bodily fluid of a patient.

According to the example embodiment, the device capable of determining the optical density is a micro plate reader.

Still another example embodiment of the present invention discloses a method of manufacturing the micro device and the aperture included in the kit.

In this case, the micro device and the aperture may be manufactured by using a 3D printing process.

According to the example embodiment, wherein the 3D printing process include: forming a mold for the flow path and the one or more grooves, and the method further comprises attaching Polydimethylsiloxane (PDMS) to the mold and then detaching the PDMS to manufacture the micro device.

According to the present invention, the device is manufactured by 3D printing, so that it is easy to manufacture the device compared to the existing case, and it is possible to manufacture the micro device at lower costs than the conventional device.

Further, there is an effect in that it is possible to easily diagnose a disease through the disease diagnosis kit and the disease diagnosis method using the corresponding kit according to the present invention.

The effects of the present invention are not limited to the above-described effects, and not-mentioned effects will be clearly understood by those skilled in the art to which the present invention belongs from the present specification and accompanying drawings.

### BRIEF DESCRIPTION OF THE DRAWINGS

FIG. 1 is a diagram briefly describing constituent elements of a disease diagnosis kit according to the present invention.

FIGS. 2A-2C show a diagram illustrating a structure of a micro device according to the present invention.

FIGS. 3A-3G show a diagram illustrating a method of manufacturing a micro device.

FIGS. 4A-4B illustrate an adjustment of a flow rate of a sample by using the micro device, a pump, and a flow rate adjusting device according to the present invention.

FIG. 5 is a diagram illustrating the degree of sample trapping when the flow rate of the sample is adjusted according to FIGS. 4A-4B.

FIG. 6 is a graph illustrating a trapping rate according to the adjustment of the flow rate of the sample.

FIGS. 7A-7D illustrate an injection of a reagent into the micro device.

FIGS. 8A-8B illustrate reaction of a sample and a reagent according to one example.

FIGS. 9A-9D illustrate the result obtained by observing the result of FIGS. 8A-8B with an optical microscope.

FIGS. 10A-10F illustrate the case where an aperture is used for deriving the result according to FIGS. 9A-9D.

FIGS. 11A-11B are result graphs of measuring optical density without using the aperture according to the present invention.

FIGS. 12A-12B are result graphs of measuring optical density by using an aperture according to the present invention.

FIG. 13 is a diagram illustrating a disease diagnosis method according to the present invention.

### DETAILED DESCRIPTION

Terms used in the present specification and the accompanying drawings are for easy explanation of the present invention, so that the present invention is not limited by the terms and the drawings.

A detailed description of known techniques that are not closely related to the spirit of the present invention among the technologies used in the present invention will be omitted.

Hereinafter, preferable embodiments according to embodiments of the present invention will be described with reference to accompanying drawings so as to be easily understood by a person of ordinary skill in the art. However, the present invention can be variously implemented and is not limited to the following embodiments. In the following description of the present invention, a detailed description of known functions and configurations incorporated herein is omitted to avoid making the subject matter of the present invention unclear. In addition, the same reference numerals are used throughout the drawings for parts having similar functions and actions.

Unless explicitly described to the contrary, the word “comprise” and variations such as “comprises” or “comprising” will be understood to imply the inclusion of stated elements but not the exclusion of any other elements. It will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

Terms, such as first and second, are used for describing various constituent elements, but the constituent elements are not limited by the terms. The terms are used only to discriminate one constituent element from another constituent element. For example, without departing from the scope of the invention, a first constituent element may be named as a second constituent element, and similarly a second constituent element may be named as a first constituent element.

Singular expressions used herein include plurals expressions unless they have definitely opposite meanings in the context. Accordingly, shapes, sizes, and the like of the elements in the drawing may be exaggerated for clearer description.

The term “˜unit” used in the present specification is a unit for processing at least one function or operation, and may mean, for example, a hardware element, such as an FPGA or an ASIC. However, the “˜unit” is not limited to software or hardware. The “˜unit” may also be configured to be included in an addressable storage medium, and may be configured to reproduce one or more processors.

As an example, the “˜unit” includes components, such as software components, object-oriented software components, class components, and task components, and processes, functions, attributes, procedures, subroutines, segments of a program code, drivers, firmware, micro-codes, circuits, data, database, data structures, tables, arrays, and variables. Functions provided by the constituent element, “˜unit” and “˜ module” may also be separately performed by the plurality of constituent elements, “˜units” and “˜modules” and may also be combined with other additional constituent elements.

The present invention presents a kit 1 for diagnosing a disease capable of performing a medical diagnosis by using a method of manufacturing a micro device 10 by using 3D printing and measuring hemagglutination by using the manufactured micro device 10, and a disease diagnosis method using the same. According to the present invention, by using the micro device 10 formed by using 3D printing, it is possible to induce hemagglutination by using only a very small amount of specimens, and apply the induced hemagglutination to a diagnosis. The micro device 10 may be commercialized later as a biochip for diagnosis.

Hereinafter, a configuration and a manufacturing method of the kit 1 for diagnosing a disease, and a diagnosis method using the corresponding kit according to the present invention will be described in detail by using the drawings.

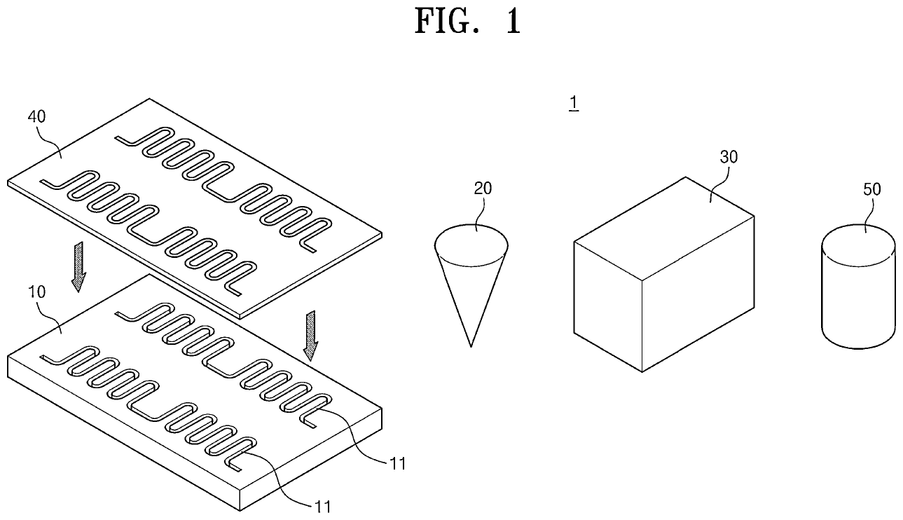

FIG. 1 is a diagram briefly describing constituent elements of the kit 1 for diagnosing a disease according to the present invention.

According to FIG. 1, the kit 1 for diagnosing a disease according to the present invention may include the micro device 10, an aperture 40, a tube 20 for injection, a flow rate adjusting device 30, and a reagent 50. Although not illustrated in FIG. 1, a bodily fluid sample may also be included in the kit 1 for diagnosing a disease.

According to the kit 1 for diagnosing a disease according to the present invention, the tube 20 for injection is coupled to the micro device 10, a sample to be diagnosed is injected into the micro device 10, and the flow rate adjusting device 30 is connected to a distal end of the micro device 10 to adjust a flow rate the sample flowing in the micro device 10. The flow rate adjusting device 30 may be coupled with the micro device 10 at a position opposite to the position where the tube 20 for injection is coupled. By adjusting the speed (flow rate) of the sample flowing in the micro device 10 by the flow rate adjusting device 30, there is an effect of increasing the probability that the sample is trapped in the micro device 10. Further, through a method of additionally injecting the reagent 50 reacting with the sample injected into the micro device 10 and combining the aperture 40 with the micro device 10 in order to observe a result of the reaction of the sample and the reagent 50, there is an effect in that it is possible to more easily diagnose the disease compared to the conventional art. According to an example, the result may be observed by combining the micro device 10 and the aperture 40 and inserting the combined micro device 10 and aperture 40 into a device capable of measuring optical density. According to the example, the device capable of measuring optical density may be a microplate reader.

The present specification discloses an example in which blood (blood cell solution) is used as the sample and an antibody solution is used as the reagent 50 reacting with the blood sample, and thus a chemical reaction for a diagnosis is induced through hemagglutination by mixing the sample and the reagent 50 in the micro device 10. According to the example, the hemagglutination may be measured and observed through a microplate reader.

However, the field to which the present invention is actually applied is not limited to the hemagglutination, and the present invention is applicable to the sample and the reagent 50 that react in various methods. In addition, through the reaction of the sample and the reagent 50, the present invention is applicable even to the case of the sample and the reagent 50 in which the reaction between the sample and the reagent 50 causes the changes in brightness. According to the example, the sample may be a bodily fluid of a patient. According to the example, the sample may be blood of a patient. According to the example, the sample may include a patient's bodily fluid, such as urine and saliva, usable for a diagnosis.

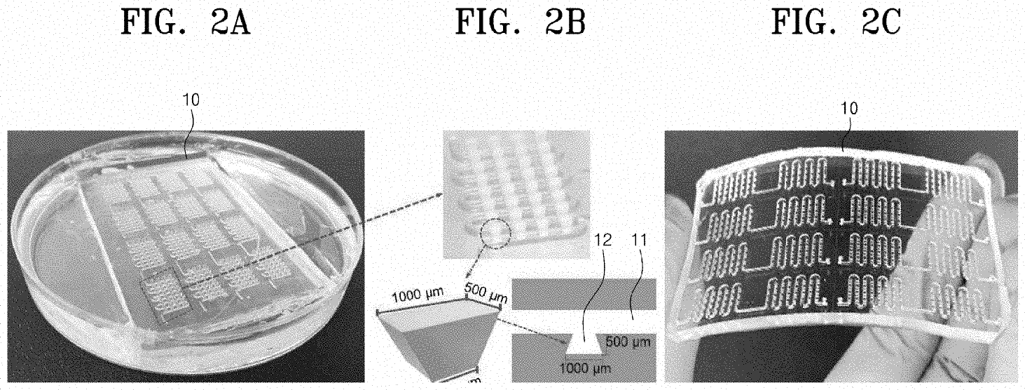

FIGS. 2A-2C illustrate a structure of the micro device 10 according to the present invention.

According to FIGS. 2A-2C, the micro device 10 according to the present invention may include a flow path 11 through which a sample to be diagnosed flows, and one or more grooves 12 formed at a bottom the flow path 11.

The flow path 11 may be formed and provided on the micro device 10 in various shape. The flow path 11 may include a straight portion and a curved portion. The flow path 11 may defines a passage, in which the sample flows, within the micro device 10 through the combination of the straight portion and the curved portion.

According to the micro device 10 according to the example of the present invention, one or more grooves 12 may be formed at the bottom the flow path 11. According to the example of FIGS. 2A to 2B, one or more grooves 12 may be formed in the straight portion of the flow path 11 at a predetermined interval. According to FIG. 2B, a cross-sectional area of the groove 12 at the portion adjacent the flow path 11 may be formed to be smaller than a cross-sectional area of the groove 12 at the portion far from the flow path 11. The portion adjacent the flow path 11 may be an upper side of the groove 12, and the portion far from the flow path 11 may be a lower side of the groove 12. According to the example, the cross-sectional area of the groove 12 may be provided in a rectangular shape. Through the structure of the groove 12, it is possible to increase the probability that the sample is trapped in the groove 12. According to the example of FIG. 2, the shape of one or more grooves 12 are the same within one flow path 11. According to the example, one or more grooves 12 may be disposed while being spaced apart from each other at a predetermined interval. That is, the micro device 10 according to the present invention has an effect in that the sample is trapped in one or more grooves 12 when the sample is injected into the micro device 10 by using the structure including the flow path 11 in which the sample can flow, and one or more grooves 12 formed at the bottom of the flow path 11.

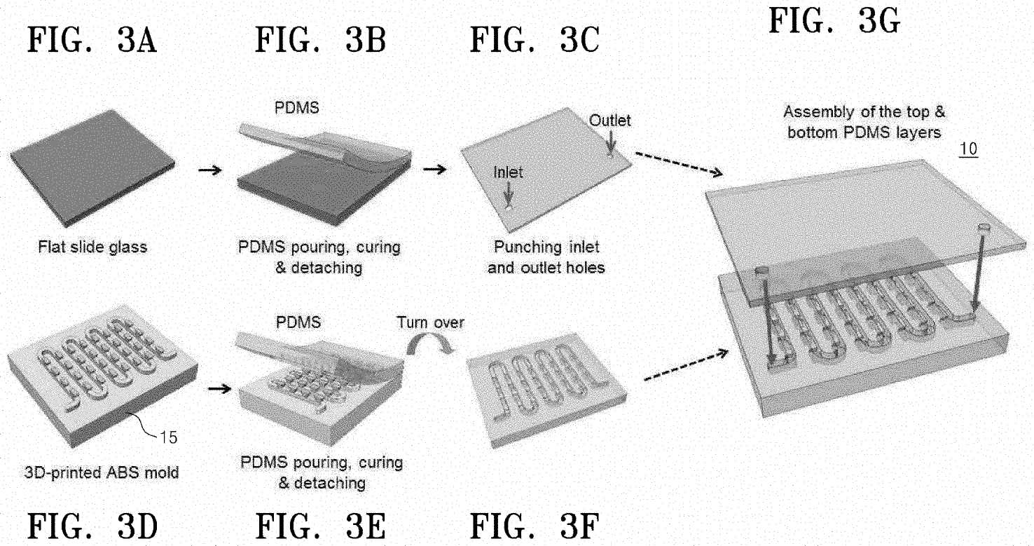

FIGS. 2A and 2C are an example in which the micro device 10 is manufactured according to FIG. 3 which is to be described below. Referring to FIGS. 2A and 2C, the plurality of flow paths 11 may be formed in one micro device 10, and the micro device 10 may be made of a flexible material.

According to FIGS. 2A to 2C, the micro device 10 formed as described above may be formed as a multi-layered structure including a micro well structure (i.e., one or more grooves 12) and a meander (i.e., the flow path 11). In manufacturing such a multi-layered structure, 3D printing may be a very useful method. The micro device 10 according to the present invention may be manufactured by using the 3D printing technology. More particularly, the shapes of the flow path 11 and the groove 12 of the micro device 10 may be formed in an embossed form by using the 3D printing technology. By using the 3D printing technology, it is possible to form an embossed mold defining the flow path 11 and the groove 12 of the micro device 10. Based on the mold, the micro device may be manufactured by using a printing method. This will be described in more detail with reference to FIG. 3.

FIGS. 3A-3G illustrate a method of manufacturing the micro device 10.

According to the example of the present invention, a 3D mold of Acrylonitrile Butadiene Styrene (ABS) material is manufactured by using Digital Light Projector (DLP) printing technology among the StereoLithography Apparatus (SLA) method that is one of the high-resolution 3D printing methods, and the micro device 10 of Polydimethylsiloxane (PDMS) material may be manufactured based on the resulting 3D mold.

FIGS. 3A to 3G are diagrams for describing the manufacturing of the 3D mold made of ABS material based on the DLP printing technology and then the manufacturing of the micro device 10 made of PDMS material.

According to FIG. 3A, a flat slide glass may be provided. According to FIG. 3B, PDMS that is the material of the micro device 10 is provided on the glass, and curing and detachment operations may be performed. According to FIG. 3C, an inlet and an outlet may be formed in the PDMS, and the resulting PDMS formed at this time may be an upper member of the micro device 10.

According to FIG. 3D, a mold in which the groove 12 and the flow path 11 are provided in an embossed form may be manufactured by using 3D printing. On the mold formed in FIG. 3D, another PDMS with a predetermined thickness may be attached, cured, and then detached (see FIGS. 3E to 3F). The resulting PDMS defining the grooves and the flow path may be a lower member of the micro device 10.

According to FIG. 3G, the micro device 10 according to the present invention may be formed by combining the upper member and the lower member. The upper member and the lower member may be manufactured of the same material. An inlet 13 and an outlet 14 may be formed in the upper member. The flow path 11 and one or more grooves 12 may be formed in the lower member. When the upper member and the lower member are combined, the inlet 13 and the outlet 14 formed in the upper member may be aligned to a start point and an end point of the flow path 11 formed in the lower member, respectively.

According to the example, the 3D printing technology for manufacturing the micro device 10 according to the present invention may be any one of the Inkjet 3D printing (i3DP) method, the SLA method, the Two-photon polymerization (2PP) method, and the Fused Deposition Modeling (FDM) method.

According to the example, the material used as the material for manufacturing the micro device 10 according to the present invention may be any one of acrylonitrile, acrylonitrile butadiene styrene (ABS), polylactic acid (PLA), Polyethylene terephthalate (PET), polydimethylsiloxane (PDMS), and poly(methyl methacrylate) (PMMA). According to the example, since the micro device 10 is made of PDMS, the PDMS is a transparent and flexible material, so it may be easy to observe the flow of fluid and chemical reaction.

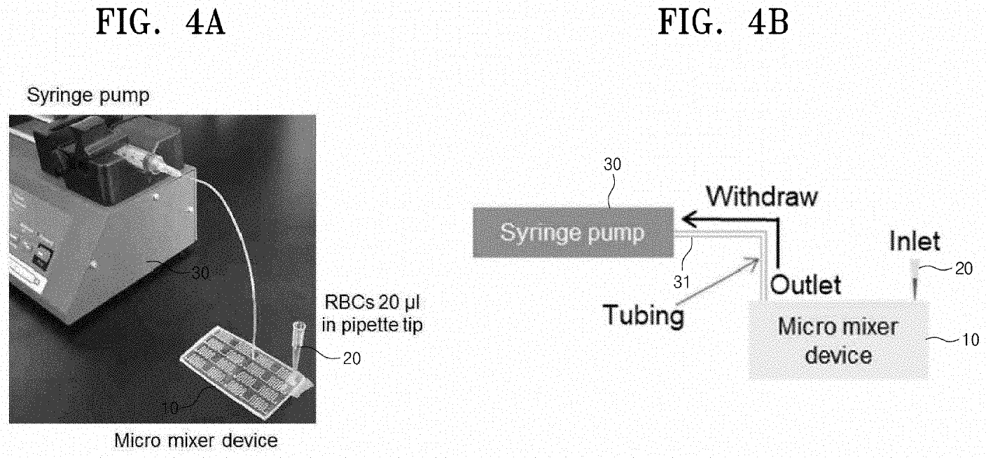

FIGS. 4A-4B illustrate an adjustment of a flow rate of a sample by using the micro device 10, a pump, and the flow rate adjusting device 30 according to the present invention.

FIG. 4A is a diagram illustrating a structure in which the flow rate adjusting device 30, the micro device 10, and the pump for injection are combined according to the example embodiment, and FIG. 4B is a diagram simply illustrating the combined structure.

According to the example of FIGS. 4A-4B, the flow rate adjusting device according to the present invention may be a syringe pump. According to another example, the flow rate adjusting device 30 may be a peristaltic pump or a piston pump.

According to the example, the tube 20 for injection according to the present invention may be a pipette tip. According to the example, after a blood sample is enriched through a centrifugation process, the blood sample may be injected into the micro device 10 by using the syringe pump.

According to the example, by controlling a flow rate of the solution injected into the micro device 10, there is an effect of stably trapping blood or a blood cell solution in one or more grooves 12 in the micro device 10.

According to FIGS. 4A-4B, the tube 20 for injection may be coupled to the inlet 13 of the micro device 10, and the flow rate adjusting device 30 may be connected to the outlet 14 of the micro device 10. It is possible to adjust the flow rate of the sample flowing in the micro device 10 by adjusting pressure applied from the flow rate adjusting device 30 connected to the outlet 14. The outlet 14 and the flow rate adjusting device 30 may be connected through a transparent pipe 31.

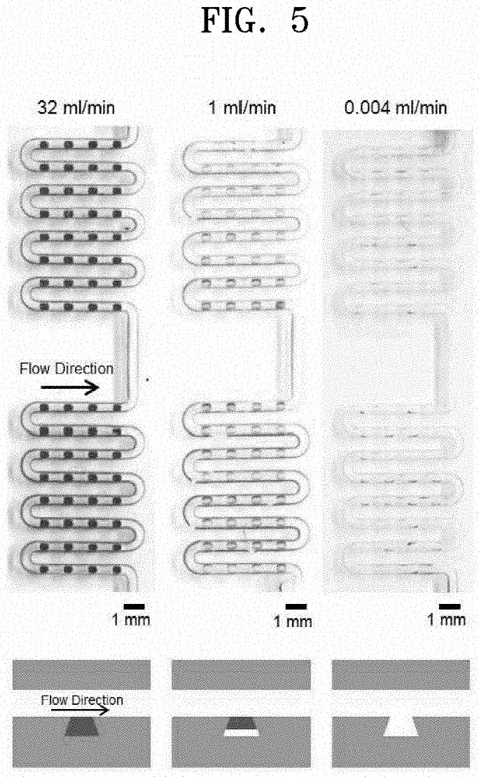

FIG. 5 is a diagram illustrating the degree of sample trapping when the flow rate of the sample is adjusted according to FIGS. 4A-4B.

FIG. 5 is a diagram showing the result of injecting the sample with the flow rates set to 32 ml/min, 1 ml/min, and 0.004 ml/min, respectively. The sample injected at this time is the blood cell solution.

According to FIG. 5, it can be seen that as the flow rate is set to be higher in the flow rate adjusting device 30, the amount of samples trapped in the groove 12 is greater.

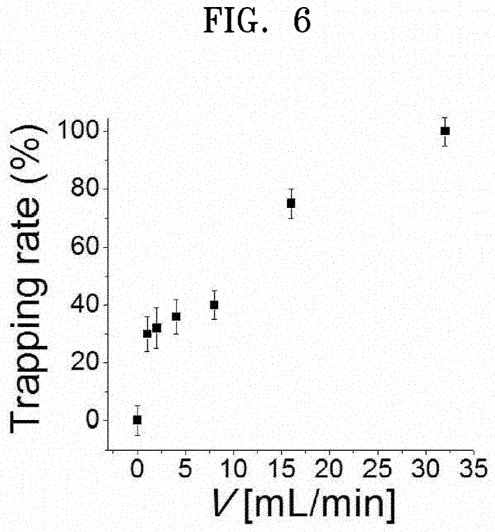

FIG. 6 is a graph illustrating a trapping rate according to the adjustment of the flow rate of the sample.

According to FIG. 6, it can be seen that when the flow rate is 15 ml/min or more, the rate at which the sample is trapped in the groove 12 is significantly increased to about 75% or more. Further, it can be seen that as the flow rate is higher, the probability that the sample is trapped is remarkably increased.

That is, according to the present invention, by controlling the flow rate with the flow rate adjusting device 30, more samples are trapped in the groove 12 of the micro device 10, thereby achieving the effect in that the trapping rate is increased even with a small amount of samples.

According to another example of the present invention, if a material with good affinity with the sample is used by changing the material constituting the micro device, the sample may also be trapped in the groove even when the flow rate of the sample is lower.

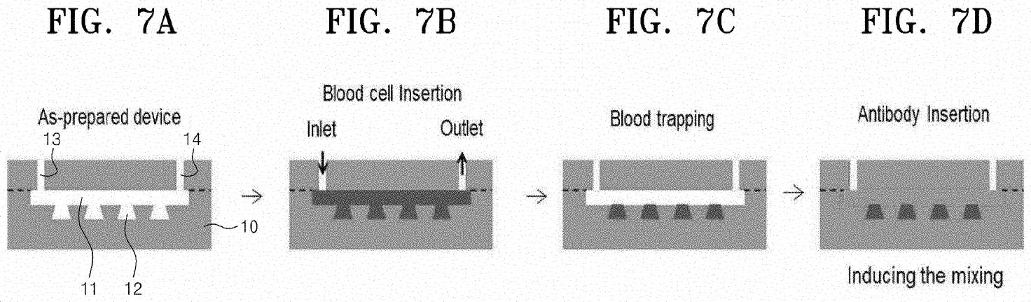

FIGS. 7A-7D are cross-sectional views of the micro device 9 for illustrating an injection of the reagent 50 into the micro device 10.

FIG. 7A is a diagram illustrating the state in which nothing is injected into the micro device 10 according to the present invention. FIG. 7B is a diagram illustrating the state in which the sample is injected into the micro device 10 according to the present invention. FIG. 7C is a diagram illustrating the state in which the sample is trapped in the groove 12 by adjusting the flow rate of the sample when the sample is injected in the micro device 10 in FIG. 7B. FIG. 7D is a diagram illustrating the injection of the reagent 50 reacting with the sample into the flow path 11 in the state where the sample is trapped in one or more grooves 12. Through this, the reagent 50 included in the flow path 11 and the sample trapped in the groove 12 may react. According to the example, the reagent 50 may be an antibody reacting with the blood cell.

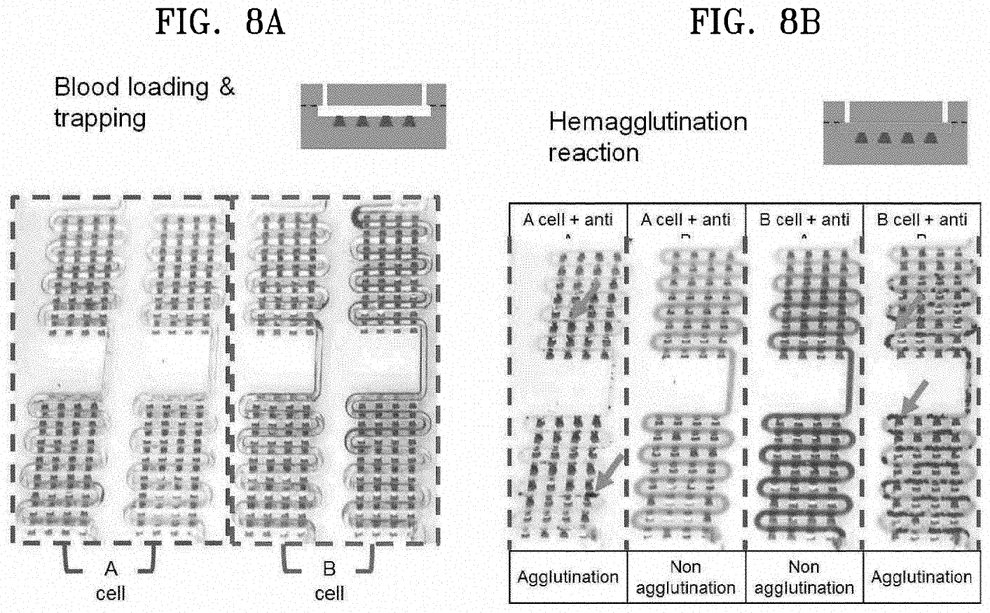

FIGS. 8A-8B illustrate the reaction of the sample and the reagent 50 according to one example.

FIG. 8A is a diagram illustrating the case where the sample is trapped in the groove 12 as illustrated in FIG. 7C. The micro device 10 shown in the left side in FIG. 8A was injected with a type A blood cell solution as a sample, and the micro device 10 shown in the right side in FIG. 8A was injected with a type B blood cell solution as a sample. FIG. 8B is a diagram showing the injection of the type A blood cell antibody and the type B blood cell antibody into the micro device 10 of FIG. 8A, respectively. The sample and the antibody used in an experiment in the present invention react with each other in the case of the type A blood cell solution and the type A blood cell antibody to exhibit agglutination, and react with each other in the case of the type B blood cell solution and the type B blood cell antibody to exhibit agglutination. The case of other combinations, agglutination does not appear.

Therefore, according to FIG. 8B, it can be seen that as a result of injecting the antibody reagent 50 and mixing the antibody reagent 50 with the blood cell (blood cell solution), and then inducing the hemagglutination, hemagglutination occurs in the first flow path and the fourth flow path.

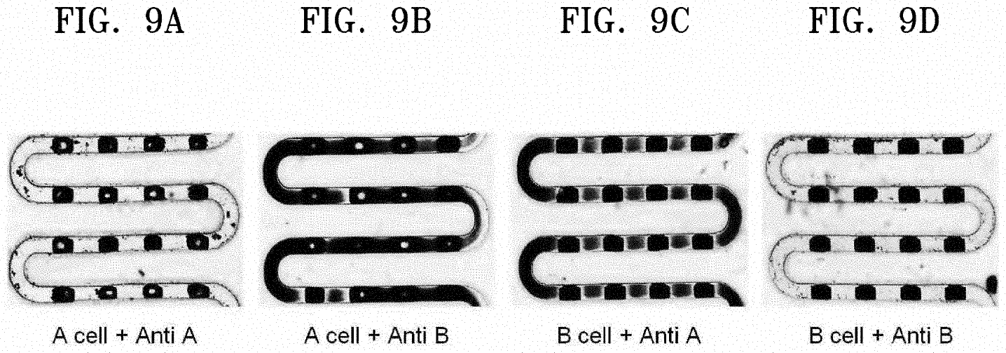

FIGS. 9A-9D illustrate the result obtained by observing the result of FIGS. 8A-8B with an optical microscope.

FIG. 9A is the result of the combination of the type A blood cell solution and the type A blood cell antibody, FIG. 9B is the result of the combination of the type A blood cell solution and the type B blood cell antibody, FIG. 9C is the result of the combination of the type B blood cell solution and the type A blood cell antibody, and FIG. 9D is the result of the combination of the type B blood cell solution and the type B blood cell antibody.

According to FIGS. 9A and 9D, when the hemagglutination occurs, since the solution becomes clear due to the formation of the aggregate, there is an effect in that the overall brightness of the flow path 11 of the micro device 10 is brightened. On the other hand, according to FIGS. 9B and 9C, when the hemagglutination does not occur, the blood cells and the antibody are physically uniformly mixed, so that there is an effect in that the overall brightness of the flow path 11 of the micro device 10 is reduced. That is, there is an effect in that it is possible to determine whether a hemagglutination has occurred by determining the brightness of the flow path 11. That is, there is a change in optical density depending on the case in which the hemagglutination occurs and the case in which the hemagglutination does not occur. However, in the convention art, even if the micro device 10 is put in a device for measuring optical density to determine the brightness of the flow path 11 as described above, it is difficult to properly determine the difference in optical density due to the brightness of the transparent portion around the flow path 11.

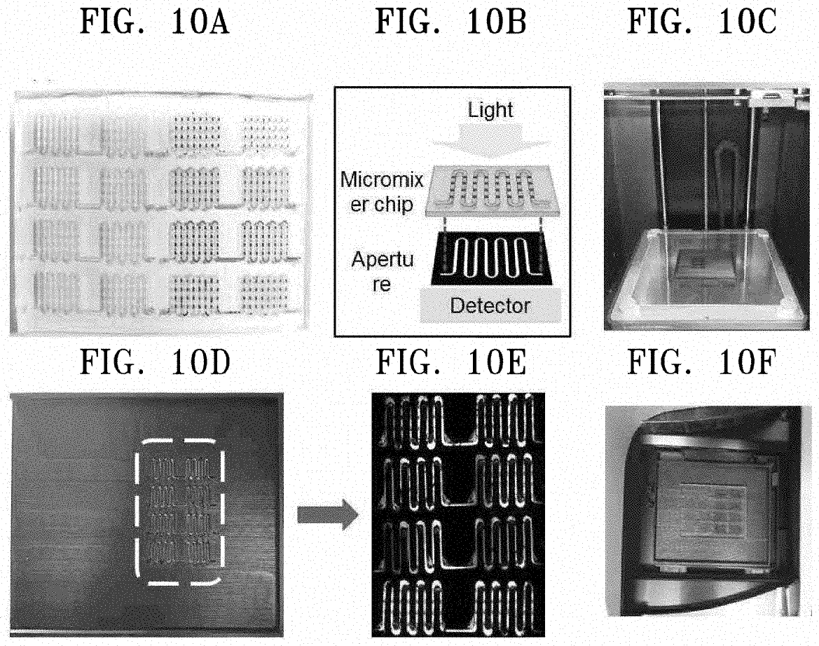

FIGS. 10A-10F illustrate the case where the aperture 40 is used for deriving the result according to FIG. 9.

FIG. 10A is a diagram illustrating the micro device 10 in the state where the sample is injected into the micro device 10 and the reagents 50 reacting with the injected sample are injected. FIG. 10B is a diagram illustrating the principle of the aperture 40 according to the present invention. FIG. 10C is a process of printing the aperture 40, and FIG. 10D is a diagram illustrating the aperture 40 formed as a result of the 3D printing. FIG. 10E is a diagram illustrating the process of aligning the aperture 40 formed according to FIG. 10D so as to have an opening corresponding with the flow path 11 of the micro device 10, and FIG. 10F is a diagram illustrating the case where the micro device 10 is inserted into a micro plate reader.

That is, according to the present invention, the structure of the aperture 40 having shape(opening) corresponding with the micro device 10 may be manufactured by using a 3D printer, and the structure of the aperture 40 may be applied to the micro device 10 and the micro plate reader. Referring to FIG. 10B, the aperture 40 according to the present invention may be manufactured through the 3D printing method as to hide the peripheral transparent portion, except for the flow path 11 formed in the micro device 10. That is, the aperture 40 according to the present invention allows light to pass through only the flow path 11 in the micro device 10, so it may be easy to observe the aggregation reaction occurring in the micro device 10. That is, the aperture 40 according to the present invention may be formed by removing portions of non-transparent material corresponding with the flow path 11 of the micro device 10.

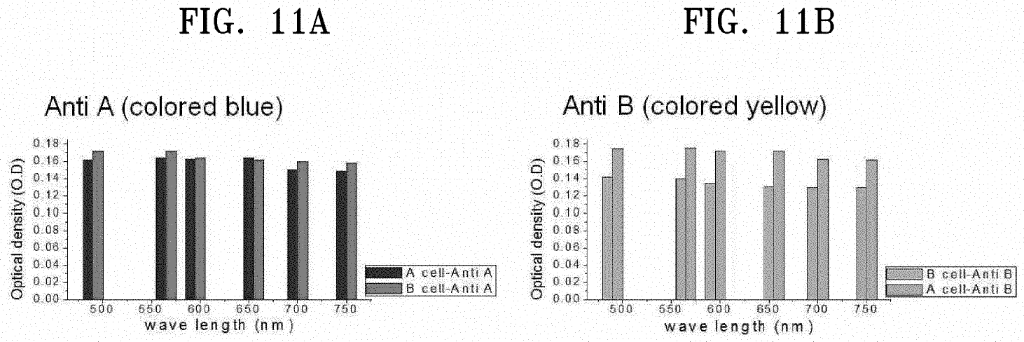

FIGS. 11A-11B are result graphs of measuring optical density without using the aperture according to the present invention.

According to FIGS. 11A-11B, after mixing the blood cell and the antibody reagent 50 in the micro device 10, when optical density is measured with the micro plate reader, the periphery of the flow path 11 is bright, so that there is a problem in that it is difficult to distinguish the change in brightness of the flow path 11 according to the hemagglutination. According to FIGS. 11A-11B, since the difference in optical density was about 0.02 to 0.05, which are very small, there was a problem in that it is difficult to distinguish the change in the brightness.

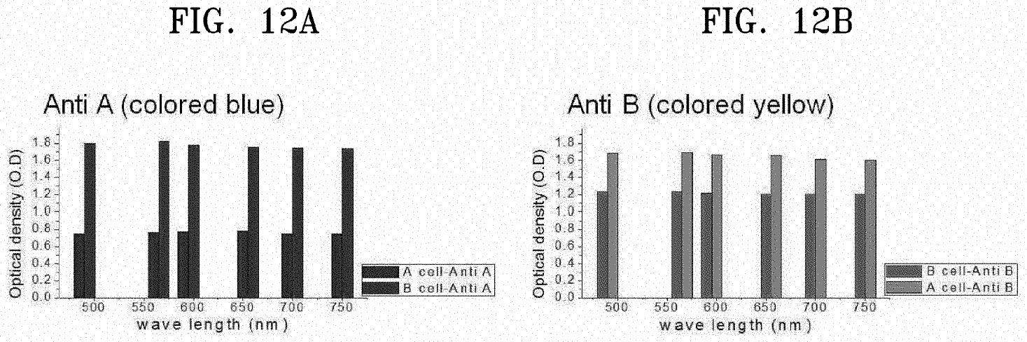

FIGS. 12A-12B is a result graph of measuring optical density by using the aperture 40 according to the present invention.

As illustrated in FIGS. 12A-12B, when the aperture 40 is used for determining the hemagglutination occurring in the micro device 10 according to the present invention, it can be confirmed that the optical density is distinguished and determined higher than that of FIG. 11. That is, by using the aperture 40, it is possible to effectively distinguish the change in the brightness of the flow path 11 caused by the hemagglutination through the change in the optical density. Compared with FIG. 11, the difference in optical density (OD) is 0.5 to 1.0, and it can be seen that there is an effect of increasing the difference in optical density values by about 20 times compared to the case where the aperture 40 is not used.

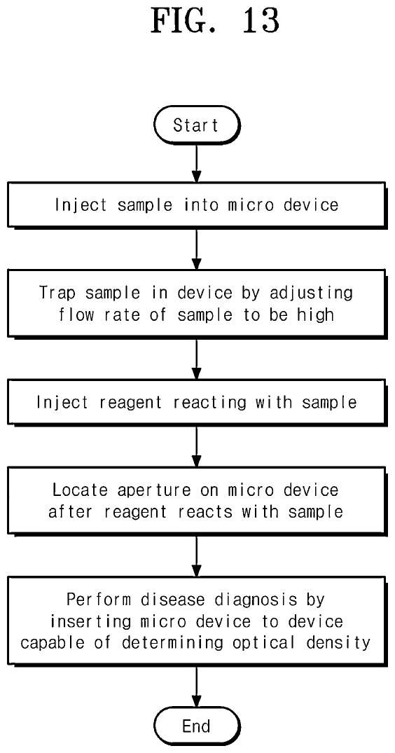

FIG. 13 is a diagram illustrating a disease diagnosis method according to the present invention.

A disease diagnosis method according to the present invention may use the kit 1 for diagnosing a disease. The disease diagnosis method according to the present invention may include an operation of injecting a sample into the micro device 10. The sample may be injected into the micro device 10 while a flow rate of the sample is adjusted to a flow rate at which the sample may be trapped in one or more grooves 12. When the sample is trapped in the one or more grooves 12 at a certain level or more, the reagent 50 capable of reacting with the sample may be injected into the micro device 10. Through this, when the sample trapped in the grooves 12 within the micro device 10 and the reagent 50 flowing in the flow path 11 react with each other, hemagglutination may occur, and when the sample trapped in the grooves within the micro device 10 and the reagent 50 flowing in the flow path 11 do react with each other, hemagglutination may not occur. In order to observe the reaction, the aperture 40 formed by using the 3D printing may be located over the micro device 10. The micro device 10 may be inserted into the device capable of determining optical density in the state where the aperture 40 and the micro device 10 are combined to determine whether hemagglutination occurs, and a result of the determination may be used for diagnosing a disease. According to the example, by observing the hemagglutination in the micro device 10 according to the present invention, the present invention may be applied to various disease diagnosis fields, such as ABO blood type test, syphilis diagnostic test, influenza (flu) diagnostic test, and virus test.

That is, according to the present invention, the micro device 10 is manufactured by using 3D printing, thereby reducing costs in the manufacturing process. Further, the micro device 10 is provided in the structure in which the sample may be trapped by easily implementing the multi-layered structure by using 3D printing and adjusting a flow rate of blood in the micro device 10, thereby optimizing the condition under which the blood is trapped in the groove 12. Further, in order to easily observe the hemagglutination, the aperture 40 is used, so that there is an effect of making it easier to observe the result.

The foregoing example embodiments are presented for helping the understanding of the present invention, and do not limit the scope of the present invention, and it should be understood that various modified example embodiments from the foregoing example embodiments are also included in the scope of the present invention. The technical scope of the present invention will be defined by the technical spirit of the accompanying claims, and it should be understood that the technical sprit of the present invention is not limited to the literal description of the claims itself, but substantially extends to the invention of an equivalent scope of the technical value.

1. A kit for diagnosing a disease, comprising:
a micro device including a flow path through which a sample to be diagnosed can flow, and one or more grooves at a bottom portion of the flow path; and
an aperture having an opening corresponding with the flow path.

2. The kit of claim 1, further comprising a flow rate adjusting device configured to adjust a flow rate of the sample flowing through the flow path of the micro device.

3. The kit of claim 2, wherein the micro device comprises:
an inlet through which the sample can be injected; and
an outlet through which the sample can be discharged; and
wherein the kit comprises a tube connected to the inlet and configured to inject the sample into the inlet.

4. The kit of claim 3, wherein the flow rate adjusting device is coupled to the outlet to adjust a flow rate of the sample to a speed at which the sample flowing in the flow path is trapped in the one or more grooves.

5. The kit of claim 3, wherein the flow rate adjusting device is coupled to the outlet to adjust the flow rate of the sample flowing in the flow path to 15 mL/min or more.

6. The kit of claim 1, wherein a cross-sectional area of a groove adjacent the flow path is narrower than a cross-sectional area of a groove far from the flow path.

7. The kit of claim 6, comprising a reagent capable of reacting with the sample.

8. A method of diagnosing a disease by using the kit according to claim 1, the method comprising:
injecting the sample into the micro device;
injecting a reagent reacting with the sample into the micro device;
locating the aperture over the micro device to observe the flow path; and
inserting the micro device to a device capable of determining optical density to diagnose a disease.

9. The method of claim 8, wherein injecting of the sample into the micro device comprises injecting the sample at a flow rate such that the sample is trapped in the one or more grooves.

10. The method of claim 8, wherein the injecting of the sample into the micro device comprises injecting the sample at a flow rate such of about 15 mL/min or more.

11. The method of claim 9, wherein injecting of the reagent reacting with the sample into the micro device comprises injecting the reagent after the sample is trapped in the one or more grooves.

12. The method of claim 11, wherein the sample is a bodily fluid of a patient.

13. The method of claim 11, wherein the device capable of determining the optical density is a micro plate reader.

14. A method of manufacturing the kit of claim 1, the method comprising manufacturing the micro device and the aperture by using a 3D printing process.

15. The method of claim 14, wherein the 3D printing process comprises forming an embossed mold for the flow path and the one or more grooves, and the method further comprises attaching Polydimethylsiloxane (PDMS) to the mold and then detaching the PDMS to manufacture the micro device.
